(19) United States
(12) Patent Application Publication
(10) Pub. No.: US 2026/0236272 A1
(43) Pub. Date: Aug. 13, 2026

(54) PLUGIN ADDING METHOD, APPARATUS, ELECTRONIC DEVICE, AND STORAGE MEDIUM

(71) Applicant: Beijing Zitiao Network Technology Co., Ltd., Beijing (CN)

(72) Inventors: Yaqi ZHANG, Beijing (CN); Chen WANG, Beijing (CN); Tao HONG, Beijing (CN); Aixin HUO, Beijing (CN); Bin WEI, Beijing (CN); Wei DENG, Beijing (CN); Jie LI, Beijing (CN); Hao LI, Beijing (CN)

(21) Appl. No.: 19/155,175

(22) PCT Filed: Feb. 6, 2024
(86) PCT No.: PCT/CN2024/076232

§ 371 Date: Aug. 8, 2025

(30) Foreign Application Priority Data
Feb. 10, 2023 (CN) 202310139031.4

(51) Int. Cl. G06F 9/445; G06F 3/0484

(52) U.S. Cl. CPC G06F 9/44526; G06F 3/0484

(57) ABSTRACT

An embodiment of the present disclosure provides a plugin adding method and apparatus, an electronic device, and a storage medium. The method comprises: presenting a target page, wherein at least one plugin adding area is provided in the target page; receiving a plugin adding operation acting on the plugin adding area, and presenting a plugin editing area corresponding to the plugin adding operation; and receiving a plugin editing operation acting on the plugin editing area, generating a target plugin based on edited plugin information, and adding the target plugin to the plugin adding area.

### CROSS-REFERENCE TO RELATED APPLICATION(S)

The present application is based on and claims priority to Chinese Patent Application No. 202310139031.4, filed on Feb. 10, 2023, and entitled “PLUGIN ADDING METHOD, APPARATUS, ELECTRONIC DEVICE, AND STORAGE MEDIUM”, which is incorporated herein by reference in its entirety.

### TECHNICAL FIELD

Embodiments of the present disclosure relate to computer application technologies and, in particular, to a plugin adding method and apparatus, an electronic device, and a storage medium.

### BACKGROUND

With the development of computer technologies, existing development projects have become more and more refined.

### SUMMARY

The present disclosure provides a plugin adding method and apparatus, an electronic device, and a storage medium to better meet project development and management requirements.

In a first aspect, an embodiment of the present disclosure provides a plugin adding method, the method includes:
presenting a target page, wherein at least one plugin adding area is provided in the target page;
receiving a plugin adding operation acting on the plugin adding area, and presenting a plugin editing area corresponding to the plugin adding operation; and
receiving a plugin editing operation acting on the plugin editing area, generating a target plugin based on edited plugin information, and adding the target plugin to the plugin adding area.

In a second aspect, an embodiment of the present disclosure further provides a plugin adding apparatus, the apparatus includes:
a page presenting module, configured to present a target page, wherein at least one plugin adding area is provided in the target page;
an editing area presenting module, configured to receive a plugin adding operation acting on the plugin adding area, and present a plugin editing area corresponding to the plugin adding operation; and
a plugin adding module, configured to receive a plugin editing operation acting on the plugin editing area, generate a target plugin based on edited plugin information, and add the target plugin to the plugin adding area.

In a third aspect, an embodiment of the present disclosure further provides an electronic device, the electronic device includes:
one or more processors; and
a memory, configured to store one or more programs,
wherein the one or more programs, when executed by the one or more processors, cause the one or more processors to implement the plugin adding method according to any one of the embodiments of the present disclosure.

In a fourth aspect, an embodiment of the present disclosure further provides a storage medium including computer-executable instructions, wherein the computer-executable instructions, when executed by a computer processor, are configured to perform the plugin adding method according to any one of the embodiments of the present disclosure.

### BRIEF DESCRIPTION OF THE DRAWINGS

The above and other features, advantages, and aspects of various embodiments of the present disclosure become more apparent when taken in conjunction with the drawings and with reference to the following detailed description. Throughout the drawings, the same or similar reference numerals refer to the same or similar elements. It should be understood that the drawings are schematic and that parts and elements are not necessarily drawn to scale.

FIG. 1A is a flowchart of a plugin adding method according to an embodiment of the present disclosure;

FIG. 1B is a schematic diagram of a control-type plugin generated according to the plugin adding method provided in an embodiment of the present disclosure;

FIG. 1C is a schematic diagram of a field-type plugin generated according to the plugin adding method provided in an embodiment of the present disclosure;

FIG. 1D is a schematic diagram of a form item container plugin generated according to the plugin adding method provided in an embodiment of the present disclosure;

FIG. 2A is a flowchart of a plugin adding method according to an embodiment of the present disclosure;

FIG. 2B is a schematic diagram of a target plugin acting on a target page according to an embodiment of the present disclosure;

FIG. 3A is a flowchart of a plugin adding method according to an embodiment of the present disclosure;

FIG. 3B is a schematic diagram of a data integration editing area according to an embodiment of the present disclosure;

FIG. 4A is a flowchart of a plugin adding method according to an embodiment of the present disclosure;

FIG. 4B is a schematic diagram of adding a target plugin to a blank display area in a page navigation bar of a target page according to an embodiment of the present disclosure;

FIG. 4C is a schematic diagram of adding a target plugin to a blank display area in a view option bar of a view page according to an embodiment of the present disclosure;

FIG. 4D is a schematic diagram of adding a target plugin to a blank display area in a work item tab bar of a work item details page according to an embodiment of the present disclosure;

FIG. 5 is a flowchart of a plugin adding method according to an embodiment of the present disclosure;

FIG. 6 is a structural diagram of a plugin adding apparatus according to an embodiment of the present disclosure; and

FIG. 7 is a structural diagram of an electronic device according to an embodiment of the present disclosure.

### DETAILED DESCRIPTION OF EMBODIMENTS

The embodiments of the present disclosure are described in more detail below with reference to the drawings. Although some embodiments of the present disclosure are shown in the drawings, it should be understood that the present disclosure may be embodied in various forms and should not be construed as limited to the embodiments set forth herein. Rather, these embodiments are provided for a thorough and complete understanding of the present disclosure. It should be understood that the drawings and embodiments of the present disclosure are only for illustrative purposes and are not intended to limit the protection scope of the present disclosure.

It should be understood that various steps described in method implementations of the present disclosure may be performed in different orders and/or in parallel. In addition, the method implementations may include additional steps and/or omit performing the illustrated steps. The scope of the present disclosure is not limited in this regard.

As used herein, the terms “include/comprise” and its variants are open-ended inclusions, that is, “include/comprise but not limited to”. The term “based on” is “based, at least in part, on”. The term “an embodiment” means “at least one embodiment”; the term “another embodiment” means “at least one additional embodiment”; the term “some embodiments” means “at least some embodiments”. Related definitions of other terms will be given in the following description.

It should be noted that concepts such as “first” and “second” mentioned in the present disclosure are only used to distinguish between different apparatuses, modules or units, and are not used to limit the order or interdependence of the functions performed by these apparatuses, modules or units.

It should be noted that the modifications of “one” and “multiple” mentioned in the present disclosure are illustrative and not restrictive, and those skilled in the art should understand that they should be understood as “one or more” unless the context clearly indicates otherwise.

The names of messages or information exchanged between multiple apparatuses in implementations of the present disclosure are only used for illustrative purposes, and are not intended to limit the scope of such messages or information.

It should be understood that, before using the technical solutions disclosed in the embodiments of the present disclosure, users should be informed of the type, scope of use, usage scenarios, and the like of personal information involved in the present disclosure through appropriate means in accordance with relevant laws and regulations, and the authorization of the users should be obtained.

For example, in response to receiving an active request from a user, prompt information is sent to the user to clearly prompt the user that the operation requested to be performed will require acquisition and use of the user's personal information. In this way, the user may independently select, based on the prompt information, whether to provide personal information to software or hardware such as an electronic device, an application, a server, or a storage medium that performs the operation of the technical solution of the present disclosure.

As an optional but non-limiting implementation, in response to receiving the active request from the user, the form of sending the prompt information to the user, for example, may be the form of a pop-up window, and the prompt information may be presented in the pop-up window in text. In addition, the pop-up window may further carry a selection control for the user to select “agree” or “disagree” to provide personal information to the electronic device.

It should be understood that the above process of notifying and acquiring user authorization is only illustrative and does not limit the implementations of the present disclosure. Other manners that satisfy relevant laws and regulations may also be applied to the implementations of the present disclosure.

It should be understood that the data involved in the technical solution (including but not limited to the data itself, acquisition or use of the data) should comply with requirements of corresponding laws, regulations, and related provisions.

With the development of computer technologies, existing development projects have become more and more refined. A project may be large in volume and complexity, and the correlation between various modules in the project is becoming stronger and stronger. This raises higher requirements for subsequent development and maintenance of the project.

In the related art, if some custom functions need to be added to a project, users usually rely on the open capabilities of a platform. However, such open capabilities are generally encapsulated independently in functions by independent robots, applications or applets, and the integration with existing function pages of the project is low. Moreover, when the open capabilities are not compatible with the custom functions of the project, it may bring difficulty to the development and management of the project, thereby affecting the user experience.

In the technical solution of the embodiments of the present disclosure, by presenting a target page, wherein one or more plugin adding areas are provided in the target page, it is possible to provide an entry for adding and improving a functional point for the user with a plugin as a carrier for the target page. Then, a plugin adding operation acting on the plugin adding area is received, and a plugin editing area corresponding to the plugin adding operation is presented to support custom editing of the plugin, thereby accurately acquiring the user requirement. Finally, a plugin editing operation acting on the plugin editing area is received, a target plugin is generated based on edited plugin information, and the target plugin is added to the plugin adding area, thereby automatically generating the target plugin that matches the user requirement. The problem of complex function maintenance of the target page and low integration with the target page is solved, and the technical effect of simply and conveniently adding a plugin to the target page to enrich and improve the page function of the target page is realized.

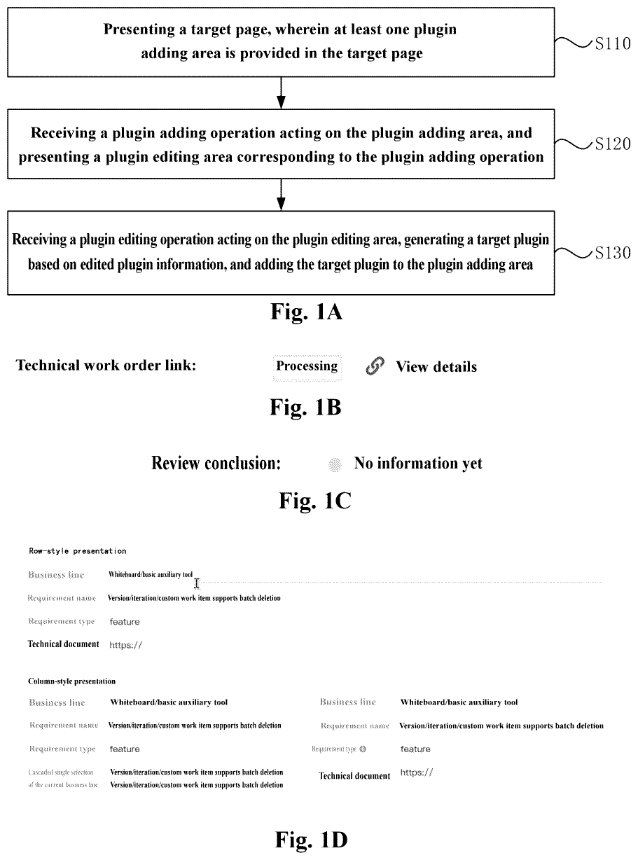

FIG. 1A is a flowchart of a plugin adding method according to an embodiment of the present disclosure. The embodiment of the present disclosure is applicable to a case where a project function is added or improved in a form of a plugin in a project management platform, and the method may be performed by a plugin adding apparatus, which may be implemented in a form of software and/or hardware, optionally, by an electronic device, which may be a mobile terminal, a personal computer (PC) terminal, a server, or the like.

As shown in FIG. 1A, the method in this embodiment may specifically include the following steps.

S110: present a target page, wherein at least one plugin adding area is provided in the target page.

The target page may be understood as a page to which a plugin is to be added, and the page type and page content of the target page are not limited here. Optionally, the target page may be a page in a project management platform. Exemplarily, the target page may be a platform home page, a view page, a work item details page, or the like. In some embodiments, the view page may include a work item view, a chart view page, or the like.

The plugin adding area may be understood as a preset area to which a plugin may be added. One or more plugin adding areas may be provided in the target page. Exemplarily, the plugin adding area includes at least one of areas such as a page navigation bar, a view option bar, a work item tab bar, and a page details area of the target page. Each plugin adding area may be used to add one or more types of plugins.

Optionally, presenting the target page may specifically include: presenting the target page when it is detected that a preset page trigger condition for the target page is reached. The page trigger condition may be a page trigger operation for the target page, or may also be preset event trigger logic, where the page trigger operation may be an operation generated through an interactive operation to present the target page. The event trigger logic may be configured to construct trigger logic based on time and/or an associated event.

S120: receiving a plugin adding operation acting on the plugin adding area, and presenting a plugin editing area corresponding to the plugin adding operation.

The plugin adding operation may be understood as an operation for adding a plugin after being triggered.

Optionally, receiving the plugin adding operation acting on the plugin adding area may specifically include: receiving a control trigger operation acting on a plugin adding control in the plugin adding area. The control trigger operation may be an operation of clicking on the plugin adding control. The plugin adding control may be understood as a control for adding the target plugin. One or more plugin adding controls may be provided in the plugin adding area.

Optionally, receiving the plugin adding operation acting on the plugin adding area may specifically include: receiving an area trigger operation acting on the plugin adding area, and presenting at least one plugin adding option; and receiving an option selection operation for the plugin adding option. The area trigger operation may be understood as an operation for presenting the plugin adding option corresponding to the plugin adding area after being triggered. The plugin adding option may be understood as an option-type control for adding the target plugin after being triggered. Each plugin adding option may correspond to one type of plugin.

In the embodiment of the present disclosure, the area trigger operation may be input in multiple manners. Exemplarily, a region click operation of clicking (for example, double-clicking or right-clicking, etc.) on the plugin adding area is received, and at least one plugin adding option is presented. Alternatively, a region click operation of clicking (for example, double-clicking or right-clicking, etc.) on the plugin adding area may be received, an option trigger control is presented, and then at least one plugin adding option is presented in response to a control trigger operation for the option trigger control. The option trigger control is configured to present, after being triggered, a control for the user to select a plugin to be added or a plugin type.

Exemplarily, the option selection operation for the plugin adding option may be an operation of clicking or pressing to expand the plugin adding option, or an operation of clicking on a preset option switching control for the plugin adding option, or the like.

The plugin editing area may be understood as an area for editing plugin information for generating a plugin. It may be understood that there are many types of plugins, and contents of different types of plugins are often different.

Optionally, before presenting the plugin editing area corresponding to the plugin adding area, the method further includes: determining a plugin type of the target plugin to be added based on the plugin adding operation, and determining the plugin editing area corresponding to the plugin adding area based on the plugin type. In some embodiments, a plugin editing area corresponding to each plugin type may be preset for each plugin type, and a correspondence between each plugin type and each plugin editing area may be established. A correspondence between the plugin type and the plugin editing area may be a one-to-one, one-to-many or many-to-one correspondence.

Similarly, a correspondence between each plugin adding area and the plugin editing area may be preset. In some embodiments, before presenting the plugin editing area corresponding to the plugin adding area, the method further includes: determining the plugin editing area corresponding to the plugin adding area based on a preset correspondence between the plugin adding area and the plugin editing area. This technical solution is particularly applicable to a case where a single type of plugin is added to the plugin adding area.

S130: receiving a plugin editing operation acting on the plugin editing area, generating the target plugin based on edited plugin information, and adding the target plugin to the plugin adding area.

Exemplarily, the target plugin includes at least one of a navigation-type plugin, a view-type plugin, a work item tab-type plugin, a form item association plugin, a button-type plugin, a data integration-type plugin, and an event-type plugin. The form item association plugin may include at least one of a control-type plugin, a field-type plugin, and a form item container plugin.

As shown in FIG. 1B-1D, a form item association plugin (a control-type plugin, a field-type plugin, and a form item container plugin) may be configured in a details page toolbar, a view page, a view toolbar, or the like, and is configured to operate a single work item or multiple work items. Exemplarily, the control-type plugin may be configured in a details page form, a node transfer form, a status transfer form, a table page, a panel page, or the like. In addition to being configured in the details page form, the node transfer form, the status transfer form, the table page, the panel page, or the like, the field-type plugin may also be configured to perform filtering or grouping. The form item container plugin may be understood as a plugin of a module configured with a details page layout, which belongs to a control and includes one or more fields and/or controls.

Exemplarily, the button-type plugin may be configured in a details page toolbar, a view page, and a view toolbar, and may be configured to operate a single work item or multiple work items.

The plugin editing operation may be understood as an operation for editing the plugin information of the target plugin. The target plugin may be understood as a plugin to be added. The plugin information may be understood as information associated with the target plugin. Exemplarily, the plugin information may include, but is not limited to, a plugin identification and/or plugin detailed information. The plugin identification may be understood as information associated with the plugin identification. It may be understood that the plugin identification is generally used to distinguish between different plugins. Exemplarily, the plugin identification may include, but is not limited to, at least one of information such as a style, a size, a color, and a display position of the plugin identification. The plugin detailed information may be understood as information for defining a specific content of the plugin of the target plugin. Exemplarily, the plugin detailed information may include, but is not limited to, at least one of information such as a plugin trigger logic, a plugin response logic, and a plugin lifecycle.

Optionally, the plugin information of the target plugin may include, but is not limited to, at least one of a work item type range, a control name, a control description, and an involved page range. The page range includes at least one of a form page layout, a table page layout, a panel page layout, a filter item, and a grouping item.

Optionally, generating the target plugin to be added based on the edited plugin information may include: generating a plugin identification and plugin detailed information of the target plugin based on the edited plugin information, and configuring a response logic between the plugin detailed information and the plugin identification to generate the target plugin to be added.

The response logic between the plugin detailed information and the plugin identification may be understood as control and response logic between the plugin identification and the plugin detailed information in an application scenario, or an association between the plugin identification and the plugin detailed information. For example, when the plugin identification is triggered, whether the plugin detailed information is displayed and its display content, etc.; on the contrary, when the plugin detailed information is triggered, whether the plugin identification is displayed and its display manner, etc.

In the embodiment of the present disclosure, there may be multiple manners of receiving the plugin editing operation acting on the plugin editing area. For example, an operation of inputting plugin editing text in the plugin editing area may be received, and/or an operation of selecting a plugin editing control in the plugin editing area may be received.

In some embodiments, the generation of the target plugin is associated with a data communication of a plugin functional component library, an entry file, and a plugin point. The plugin functional component library may be preset in a project engineering corresponding to the target page. The data communication association of the plugin point may be determined based on a data communication capability pre-injected at each plugin point in the project engineering corresponding to the target page.

The development may be performed after the plugin development environment and the basic configuration are ready. In some embodiments, the development of the function of the plugin may be performed based on the entry file in the configuration of the code compilation tool. Generally, different plugin functions correspond to different rendering functions, and for the plugin functions required by the target plugin, functional logic may be developed based on the rendering function corresponding to the plugin functions.

In the technical solution of the embodiment of the present disclosure, by presenting a target page, wherein one or more plugin adding areas are provided in the target page, it is possible to provide an entry for adding and improving a functional point for the user with a plugin as a carrier for the target page. Then, a plugin adding operation acting on the plugin adding area is received, and a plugin editing area corresponding to the plugin adding operation is presented to support custom editing of the plugin, thereby accurately acquiring the user requirement. Finally, a plugin editing operation acting on the plugin editing area is received, a target plugin is generated based on edited plugin information, and the target plugin is added to the plugin adding area, thereby automatically generating the target plugin that matches the user requirement. The problem of complex function maintenance of the target page and low integration with the target page is solved, and the technical effect of simply and conveniently adding a plugin to the target page to enrich and improve the page function of the target page is realized.

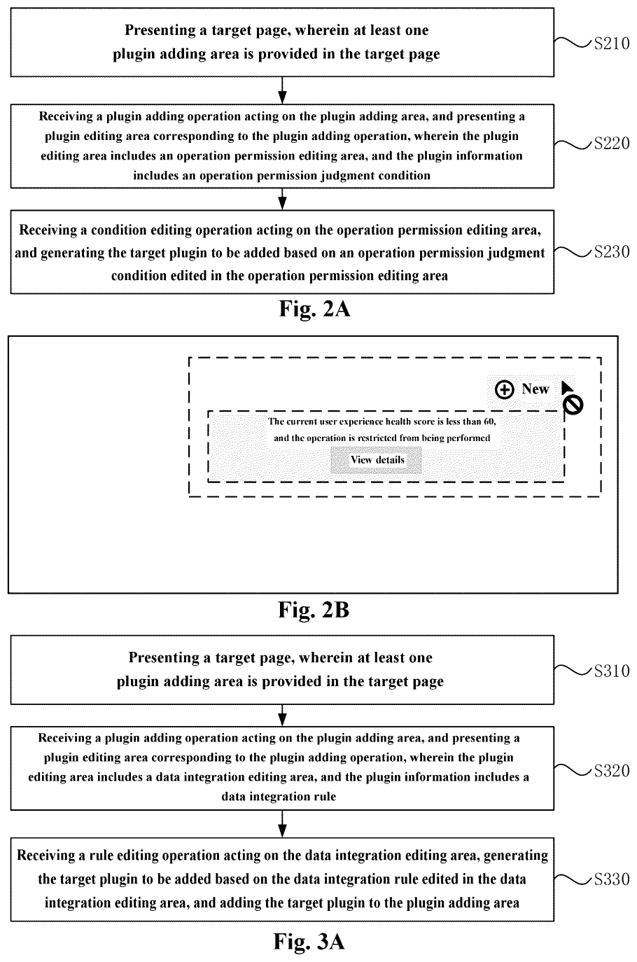

FIG. 2A is a flowchart of another plugin adding method according to an embodiment of the present disclosure. The technical solution of this embodiment further specifies how to generate a permission detection type plugin based on the preceding embodiment. Optionally, the plugin editing area includes an operation permission editing area, and the plugin information includes an operation permission judgment condition. The receiving the plugin editing operation acting on the plugin editing area, and generating the target plugin to be added based on the edited plugin information includes: receiving a condition editing operation acting on the operation permission editing area, and generating the target plugin to be added based on an operation permission judgment condition edited in the operation permission editing area. For the specific implementation, reference may be made to the description of this embodiment, among which, the technical features the same as or similar to those of the preceding embodiment are not described herein again.

As shown in FIG. 2A, the method in this embodiment may specifically include the following steps.

S210: presenting a target page, wherein at least one plugin adding area is provided in the target page.

S220: receiving a plugin adding operation acting on the plugin adding area, and presenting a plugin editing area corresponding to the plugin adding operation, wherein the plugin editing area includes an operation permission editing area, and the plugin information includes an operation permission judgment condition.

In some embodiments, the operation permission editing area is an area for editing information related to detection of an operation permission. Exemplarily, the operation permission editing area may be an area for inputting the operation permission judgment condition. Optionally, the operation permission judgment condition may be understood as a condition for determining whether an operation permission is provided. It may be understood that the operation permission is related to a specific operation, and the specific content thereof may be set according to actual requirements, which is not specifically limited here.

Exemplarily, the operation permission judgment condition may include at least one of a numerical-type judgment condition, an identity judgment condition of an operation request terminal, and an execution state condition of an associated event. Exemplarily, the numerical-type judgment condition may be a condition for judging time or a condition for a value of an event counter. The identity judgment condition of the operation request terminal may be a judgment condition for judging whether the identity information of the current operation request terminal matches preset identity information with the operation permission or without the operation permission.

Optionally, the execution state of the associated event may include whether the execution progress of the associated event to be executed before responding to the current operation reaches the preset progress corresponding to the execution progress. Further, when there are multiple associated events, the execution state of the associated event may further include whether the execution sequence of the multiple associated events is a preset sequence.

Exemplarily, presenting the plugin editing area corresponding to the plugin adding operation may be presenting the plugin editing area corresponding to the plugin adding operation in a preset display area of the target page, or presenting the plugin editing area corresponding to the plugin adding operation in a form of a pop-up window, or presenting the plugin editing area corresponding to the plugin adding operation in a form of a floating window, or jumping to a plugin editing details page and presenting the plugin editing area corresponding to the plugin adding operation in the plugin editing details page.

It may be understood that the floating window is a window presented based on a hovering operation of an input device at a preset trigger position. Generally, whether the floating window is presented depends on the hovering position of the input device. The pop-up window may be a window that pops up in the target page independently of the target page in response to a trigger operation for the plugin editing area. Generally, the pop-up window is closed by a control trigger operation acting on a preset pop-up window closing control in the pop-up window, or by detecting a preset closing trigger condition for closing the pop-up window. Exemplarily, the closing trigger condition may include that the presentation time of the pop-up window reaches a preset duration and/or that a page switching operation or a page jump operation input on the target page is received.

S230: receiving a condition editing operation acting on the operation permission editing area, generating the target plugin to be added based on the operation permission judgment condition edited in the operation permission editing area, and adding the target plugin to the plugin adding area.

The condition editing operation may be understood as an operation for editing information related to the judgment of the operation permission and used to generate the target plugin. In some embodiments, the condition editing operation may be an operation for editing the operation permission judgment condition. In the embodiment of the present disclosure, the operation permission judgment condition edited in the operation permission editing area may be used to intercept a preset operation behavior, thereby ensuring the correctness and security of the operation.

In some embodiments, the plugin adding area may be used to indicate an adding position where the target plugin needs to perform permission judgment. When multiple target plugins correspond to the same one adding position, the functional logic corresponding to the target plugins is executed in the order of installation of the target plugins.

In the embodiment of the present disclosure, typically, the plugin adding area may include a page operation control presented in the target page, such as a button in the target page.

Exemplarily, in the view page, the page operation control may include at least one of a view management control, a list page control, a batch operation control, a new page control, and a details page control.

The view management control may specifically include, but is not limited to, at least one of a setting control, a sharing control, a save as view control, a save change control, and a reset view control.

The list page control may specifically include, but is not limited to, at least one of a filter control, a sorting control, a grouping control, a line height control, and a search control.

The batch operation control may specifically include, but is not limited to, at least one of a sharing control, a creating fixed view control, an exporting control, an upgrading control, a modifying control, and a deleting control.

The new page control may include, but is not limited to, at least one of a new control, a draft control, a confirming creation control, a cancel control, and a saving as draft control.

The details page control may include at least one of a work item operation control, a node operation control, a status change control, a task operation control, a note control, and a field. The work item operation control specifically includes, but is not limited to, at least one of a chat group creating control, a following control, a copying identification control, a copying link control, a synchronous creation control, a full screen control, a work item terminating control, a work item recovering control, a template upgrading control, a deleting control, and a defect copying control. The node operation may include, but is not limited to, at least one of a node completing control, a node deleting control, a task adding control, a scheduling filling and estimating control, a node rolling back control, and a reminding control. The status change control specifically includes, but is not limited to, a button control and/or a change confirming control. The task operation control specifically includes, but is not limited to, at least one of a task creating control, a reminding control, and a note adding control. The field may include a form page, a table page, a panel page, a task deliverable, or the like.

On the basis of the preceding technical solution, optionally, the plugin adding method may further include: determining a response state of a page operation control based on an operation permission judgment condition corresponding to an operation permission detection plugin in response to a plugin trigger operation for the target plugin.

The page operation control may be understood as a control for implementing a page function in the target page. The page operation control may be a first-level control presented on the target page, or a second-level control associated with the first-level control. The first-level control may be understood as a page function control, which corresponds to a specific function or a specific function category in the page. The second-level control may be understood as a control for implementing a general function corresponding to the first-level control or a sub-function included in the function category.

In some embodiments, the response state of the page operation control may include executing response logic corresponding to the page operation control or not responding to the trigger operation for the page operation control. Further, prompt information for not responding to the trigger operation for the page operation control may also be generated and presented. It may be understood that the response logic corresponding to the page operation control is associated with the function implemented by the page operation control, and the specific response logic may be set according to actual requirements, which is not specifically limited here.

Optionally, determining the response state of the page operation control based on the operation permission judgment condition corresponding to the operation permission detection plugin includes: determining an operation permission detection result corresponding to the control trigger operation based on the operation permission judgment condition corresponding to the operation permission detection plugin. The operation permission detection result includes having the operation permission and not having the operation permission.

In some embodiments, when the operation permission detection result is having the operation permission, the response logic corresponding to the page operation control is executed; and/or when the operation permission detection result is not having the operation permission, unresponsive prompt information corresponding to the page operation control is generated. As shown in FIG. 2B, the unresponsive prompt information may be information for reminding the user that the operation for the page operation control is restricted and the reason for the restriction. When the “new” control is triggered, if it is detected, based on the target plugin, that the “new” condition is not satisfied, the unresponsive prompt information is generated and displayed based on the detection result. For example, the unresponsive prompt information may be “The current user experience health score is less than 60, and the operation is restricted from being performed”. Further, the hyperlink of “view details” may also be displayed in the unresponsive prompt information, so that the user can click on the hyperlink to view the specific reason for the restricted operation or jump to a page or a page position associated with the restriction of the operation.

In the technical solution of the embodiment of the present disclosure, the target plugin to be added may be generated through the operation permission judgment condition edited in the operation permission editing area, so that the function of the operation permission judgment is added to the target page, thereby fully ensuring the security of the page function. Moreover, the operation permission judgment condition may be configured by the user, which can well meet the individual requirements of the user and improve the user experience.

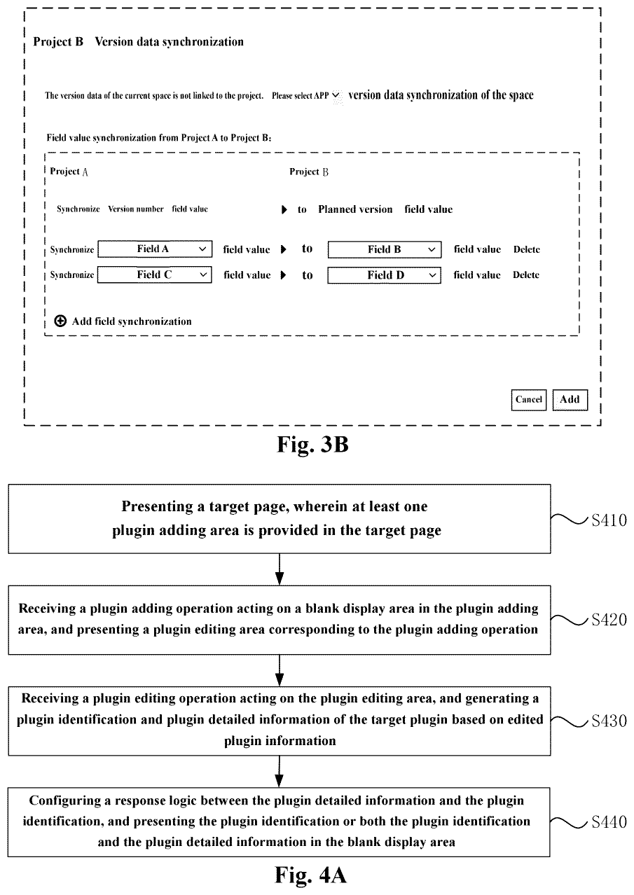

FIG. 3A is a flowchart of another plugin adding method according to an embodiment of the present disclosure. The technical solution of this embodiment further specifies how to generate an permission detection type plugin based on the preceding embodiment. Optionally, the plugin editing area includes a data integration editing area, and the plugin information includes a data integration rule. Receiving the plugin editing operation acting on the plugin editing area, and generating the target plugin to be added based on the edited plugin information includes: receiving a rule editing operation acting on the data integration editing area, and generating the target plugin to be added based on a data integration rule edited in the data integration editing area. For the specific implementation, reference may be made to the description of this embodiment. Among which, the technical features the same as or similar to those of the preceding embodiment are not described herein again.

As shown in FIG. 3A, the method in this embodiment may specifically include the following steps.

S310: presenting a target page, wherein at least one plugin adding area is provided in the target page.

S320: receiving a plugin adding operation acting on the plugin adding area, and presenting a plugin editing area corresponding to the plugin adding operation, wherein the plugin editing area includes a data integration editing area, and the plugin information includes a data integration rule.

In some embodiments, the data integration editing area may be understood as an area for editing information related to the data integration. Typically, the data integration editing area may be an area for editing the data integration rule. The data integration rule may be understood as a rule for converting data in a current format into data in a target format. Exemplarily, the data integration rule may be a rule for processing data of a data sender according to a data format of a data receiver to obtain data of the data receiver.

FIG. 3B is a schematic diagram of a data integration editing area according to an embodiment of the present disclosure. As shown in FIG. 3B, taking data communication between project A (assuming that it is a local platform) and project B (assuming that it is a third-party platform) as an example, the data integration rule may be used to carry a data communication rule of the third-party platform, and may be specifically configured in a plugin list of the target plugin after the target plugin is installed. Through the data integration editing area, a configuration item required by the target plugin may be customized, configuration data corresponding to the target plugin may be acquired, and some display or linkage rules related to the target plugin may be executed. The data integration rule may include a rule for establishing a mapping relationship between the field value of the project A and the field value of the project B.

In some embodiments, the generation of the data integration rule may include setting a data synchronization rule and a data mapping rule. The data synchronization rule includes a data synchronization range (a dimension for filtering data synchronization) and/or a data synchronization address (such as a synchronization field). The data mapping rule may include a list of fields available for mapping, which may specifically include filtered data and mapped data.

S330, receiving a rule editing operation acting on the data integration editing area, generating the target plugin to be added based on the data integration rule edited in the data integration editing area, and adding the target plugin to the plugin adding area.

It should be noted that one target plugin may be associated with one or more project engineering, or one target plugin may include the local platform or be associated with one or more third-party platforms associated with the local platform. There may be one or more data integration rules corresponding to the local platform and one third-party platform associated with the local platform. Therefore, one target plugin supports the configuration of one or more data integration rules.

On the basis of the preceding technical solution, optionally, the plugin adding method in the embodiment of the present disclosure further includes: acquiring data to be processed corresponding to a plugin trigger operation in response to the plugin trigger operation for the target plugin; and converting the data to be processed into target data based on a data integration rule corresponding to the target plugin. The data to be processed may be understood as data to be converted. It may be understood that the specific content of the data to be processed is associated with the control trigger operation.

In the technical solution of the embodiment of the present disclosure, the target plugin to be added is generated through the data integration rule edited in the data integration editing area, so that data intercommunication can be achieved simply and effectively based on the plugin, thereby improving the data compatibility of the target page, improving the page function, and improving the user experience.

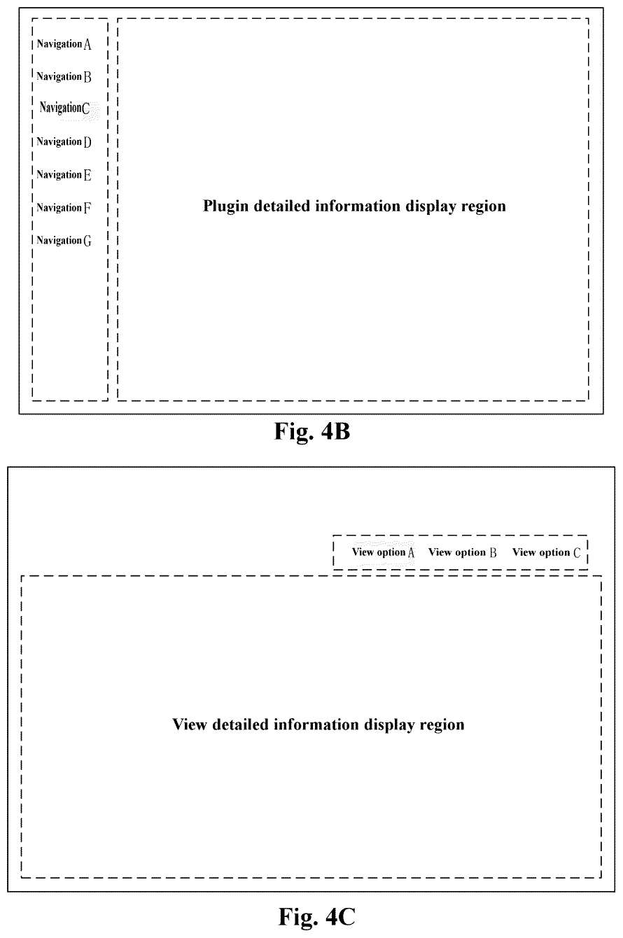

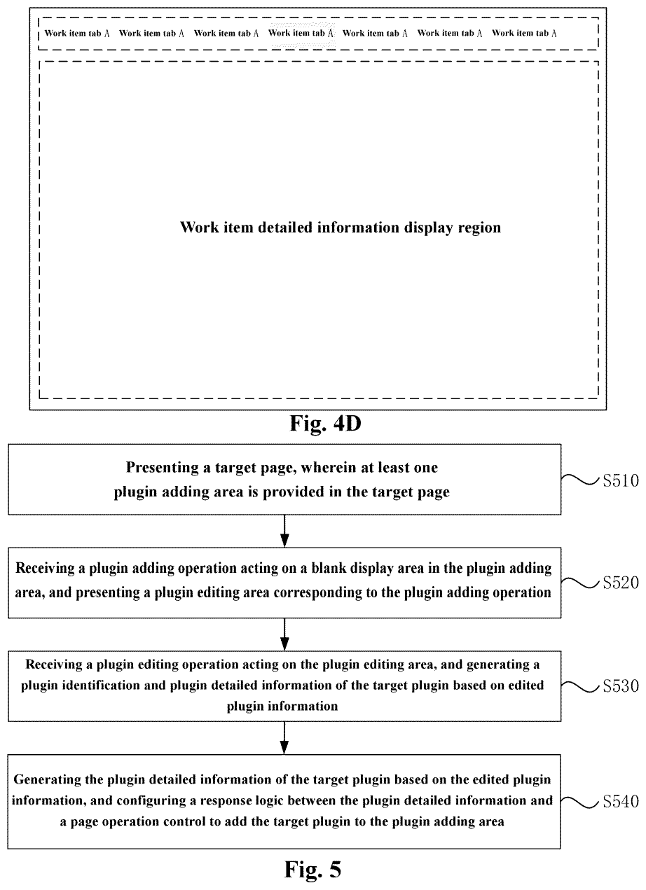

FIG. 4A is a flowchart of another plugin adding method according to an embodiment of the present disclosure. The technical solution of this embodiment further specifies how to generate a data integration-type plugin based on the preceding embodiment. Optionally, the plugin editing area includes a data integration editing area, and the plugin information includes a data integration rule. Receiving the plugin editing operation acting on the plugin editing area, and generating the target plugin to be added based on the edited plugin information includes: receiving a rule editing operation acting on the data integration editing area, and generating the target plugin to be added based on a data integration rule edited in the data integration editing area. For the specific implementation, reference may be made to the description of this embodiment. Among which, the technical features the same as or similar to those of the preceding embodiment are not described herein again.

As shown in FIG. 4A, the method in this embodiment may specifically include the following steps.

S410: presenting a target page, wherein at least one plugin adding area is provided in the target page.

S420: receiving a plugin adding operation acting on a blank display area in the plugin adding area, and presenting a plugin editing area corresponding to the plugin adding operation.

The blank display area in the plugin adding area may be understood as an area in which no configured information is displayed in the plugin adding area.

In some embodiments, the plugin adding operation for the blank display area in the plugin adding area may be understood as an operation for adding the target plugin in the blank display area in the plugin adding area. Optionally, the added target plugin is independent of existing functions in the plugin adding area.

Optionally, receiving the plugin adding operation for the blank display area in the plugin adding area specifically includes: receiving a control trigger operation acting on the blank display area in the plugin adding area, and presenting at least one plugin adding option corresponding to the blank display area; and receiving an option selection operation for the plugin adding option.

S430: receiving a plugin editing operation acting on the plugin editing area, and generating a plugin identification and plugin detailed information of the target plugin based on edited plugin information.

S440: configuring a response logic between the plugin detailed information and the plugin identification, and presenting the plugin identification or both the plugin identification and the plugin detailed information in the blank display area.

Optionally, presenting the plugin identification in the blank display area includes: determining an operation input position when the plugin adding operation is input in the blank display area, and inserting the plugin identification into the operation input position for presentation; or presenting the plugin identification at an idle position in the blank display area based on a preset identification arrangement rule corresponding to the blank display area, where the identification arrangement rule includes arranging according to an identification name or arranging according to identification generation time.

As shown in FIG. 4B, in the case where the plugin adding area is a page navigation bar of the target page and the plugin adding operation for the blank display area in the page navigation bar is received, the plugin identification of the target plugin may be inserted into a position in the page navigation bar where the plugin adding operation is triggered; alternatively, the plugin identification of the target plugin may be added to a blank position of the page navigation bar, and then the plugin identification of the target plugin is dragged to insert the plugin identification into a drag position.

As shown in FIG. 4C, in the case where the plugin adding area is a view option bar of the view page and the plugin adding operation for the blank display area in the view option bar is received, the plugin identification of the target plugin may be inserted into a position in the view option bar where the plugin adding operation is triggered; alternatively, the plugin identification of the target plugin may be added to a blank position of the view option bar, and then the plugin identification of the target plugin is dragged to insert the plugin identification into a drag position.

As shown in FIG. 4D, in the case where the plugin adding area is the work item tab bar of the work item details page and the plugin adding operation for the blank display area in the work item tab bar is received, the plugin identification of the target plugin may be inserted into a position in the work item tab bar where the plugin adding operation is triggered; alternatively, the plugin identification of the target plugin may be added to a blank position of the work item tab bar, and then the plugin identification of the target plugin is dragged to insert the plugin identification into a drag position.

Optionally, in the case where the plugin identification is presented on the target page, the plugin detailed information may be presented based on an identification trigger operation in response to the identification trigger operation for the plugin identification.

In the technical solution of the embodiment of the present disclosure, the target plugin may be generated through the trigger operation for the blank display area in the plugin adding area, and the target plugin is added to the plugin adding area, and the plugin identification of the target plugin is presented or both the plugin identification and the plugin detailed information are presented, so that the user can intuitively see the added plugin, and the interaction between the user and the target plugin is facilitated, thereby better satisfying the individual interaction requirements of the user.

FIG. 5 is a flowchart of another plugin adding method according to an embodiment of the present disclosure. The technical solution of this embodiment further specifies how to generate a data integration-type plugin based on the preceding embodiment. Optionally, the plugin editing area includes a data integration editing area, and the plugin information includes a data integration rule. Receiving the plugin editing operation acting on the plugin editing area, and generating the target plugin to be added based on the edited plugin information includes: receiving a rule editing operation acting on the data integration editing area, and generating the target plugin to be added based on a data integration rule edited in the data integration editing area. For the specific implementation, reference may be made to the description of this embodiment. Among which, the technical features the same as or similar to those of the preceding embodiment are not described herein again.

As shown in FIG. 5, the method in this embodiment may specifically include the following steps.

S510: presenting a target page, wherein at least one plugin adding area is provided in the target page.

S520: receiving a plugin adding operation for a page operation control in the plugin adding area, and present a plugin editing area corresponding to the plugin adding operation.

The page operation control may be understood as an operation control presented on the target page. In some embodiments, the plugin adding operation acting on the page operation control in the plugin adding area is an operation generated by acting on the page operation control in the plugin adding area to add the target plugin associated with the page operation control.

Similarly, receiving the plugin adding operation for the page operation control in the plugin adding area specifically includes: receiving a control trigger operation acting on the page operation control in the plugin adding area, and presenting at least one plugin adding option corresponding to the page operation control; and receiving an option selection operation for the plugin adding option.

In S530, receiving a plugin editing operation acting on the plugin editing area, and generating a plugin identification and plugin detailed information of the target plugin based on edited plugin information.

In S540, generating the plugin detailed information of the target plugin based on the edited plugin information, and configuring a response logic between the plugin detailed information and the page operation control to add the target plugin to the plugin adding area.

The response logic between the plugin detailed information and the page operation control may be understood as control and response logic between the page operation control and the plugin detailed information in an application scenario, or an association between the page operation control and the plugin detailed information. For example, when the page operation control is triggered, whether the plugin detailed information is displayed and its display content, etc.; on the contrary, when the plugin detailed information is triggered, the display manner of the page operation control, etc.

On the basis of the preceding technical solution, the plugin detailed information of the target plugin may be viewed through the page operation control. In some embodiments, the plugin detailed information may be presented based on the control trigger operation in response to the control trigger operation for the page operation control.

As another optional solution of the embodiment of the present disclosure, generating the target plugin based on the edited plugin information, and the adding target plugin to the plugin adding area may include: generating a plugin identification and the plugin detailed information of the target plugin based on the edited plugin information, and configuring a response logic between the plugin detailed information and the plugin identification and a response logic between the plugin identification and the page operation control to add the target plugin to the plugin adding area.

In the technical solution of the embodiment of the present disclosure, the target plugin may be added for an existing page operation control of the target page, and the function of the page operation control is improved simply and conveniently based on the target plugin, thereby saving the functional development cost, supporting the user-defined configuration, and maintaining the original display manner of the page operation control, greatly improving the user experience.

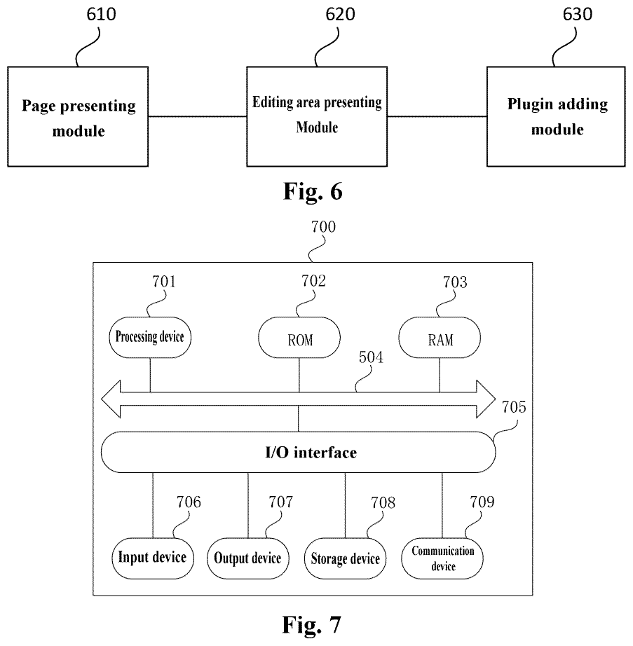

FIG. 6 is a structural diagram of a plugin adding apparatus according to an embodiment of the present disclosure. As shown in FIG. 6, the plugin adding apparatus includes a page presenting module 610, an editing area presenting module 620, and a plugin adding module 630.

The page presenting module 610 is configured to present a target page, where at least one plugin adding area is provided in the target page. The editing area presenting module 620 is configured to receive a plugin adding operation acting on the plugin adding area, and present a plugin editing area corresponding to the plugin adding operation. The plugin adding module 630 is configured to receive a plugin editing operation acting on the plugin editing area, generate a target plugin based on edited plugin information, and add the target plugin to the plugin adding area.

In the technical solution of the embodiment of the present disclosure, by presenting a target page, where one or more plugin adding areas are provided in the target page, it is possible to provide an entry for adding and improving a functional point for the user with a plugin as a carrier for the target page. Then, a plugin adding operation acting on the plugin adding area is received, and a plugin editing area corresponding to the plugin adding operation is presented to support custom editing of the plugin, thereby accurately acquiring the user requirement. Finally, a plugin editing operation acting on the plugin editing area is received, a target plugin is generated based on edited plugin information, and the target plugin is added to the plugin adding area, thereby automatically generating the target plugin that matches the user requirement. The problem of complex function maintenance of the target page and low integration with the target page is solved, and the technical effect of simply and conveniently adding a plugin to the target page to enrich and improve the page function of the target page is realized.

On the basis of any optional technical solution in the embodiment of the present disclosure, optionally, the plugin editing area includes an operation permission editing area, and the plugin information includes an operation permission judgment condition.

Further, the plugin adding module is further configured to: receive a condition editing operation acting on the operation permission editing area, and generate the target plugin to be added based on the operation permission judgment condition edited in the operation permission editing area.

On the basis of any optional technical solution in the embodiment of the present disclosure, optionally, the plugin adding apparatus further includes a control response module. The control response module is configured to determine a response state of the page operation control based on an operation permission judgment condition corresponding to an operation permission detection plugin in response to a plugin trigger operation for the target plugin.

On the basis of any optional technical solution in the embodiment of the present disclosure, optionally, the plugin editing area includes a data integration editing area, and the plugin information includes a data integration rule.

Further, the plugin adding module is further configured to: receive a rule editing operation acting on the data integration editing area, and generate the target plugin to be added based on a data integration rule edited in the data integration editing area.

On the basis of any optional technical solution in the embodiment of the present disclosure, optionally, the plugin adding apparatus further includes a data acquisition module and a data conversion module. The data acquisition module is configured to acquire data to be processed corresponding to a plugin trigger operation in response to the plugin trigger operation for the target plugin. The data conversion module is configured to convert the data to be processed into target data based on a data integration rule corresponding to the target plugin.

On the basis of any optional technical solution in the embodiment of the present disclosure, optionally, the editing area presenting module is further configured to: receive a plugin adding operation for a blank display area in the plugin adding area.

Further, the plugin adding module may further include a plugin information generation unit and a plugin information presentation unit. The plugin information generation unit is configured to generate a plugin identification and plugin detailed information of the target plugin based on the edited plugin information. The plugin information presentation unit is configured to configure a response logic between the plugin detailed information and the plugin identification, and present the plugin identification or both the plugin identification and the plugin detailed information in the blank display area.

On the basis of any optional technical solution in the embodiment of the present disclosure, optionally, the editing area presenting module is further configured to: receive a plugin adding operation acting on a page operation control in the plugin adding area.

Further, the plugin adding module is further configured to: generate the plugin detailed information of the target plugin based on the edited plugin information, and configure the response logic between the plugin detailed information and the page operation control to add the target plugin to the plugin adding area; or generate the plugin identification and the plugin detailed information of the target plugin based on the edited plugin information, and configure the response logic between the plugin detailed information and the plugin identification and the response logic between the plugin identification and the page operation control to add the target plugin to the plugin adding area.

On the basis of any optional technical solution in the embodiment of the present disclosure, optionally, the target plugin includes at least one of a navigation-type plugin, a view-type plugin, a work item tab-type plugin, a form item association plugin, a button-type plugin, a data integration-type plugin, and an event-type plugin. The form item association plugin includes at least one of a control-type plugin, a field-type plugin, and a form item container plugin.

The plugin adding apparatus provided in the embodiment of the present disclosure may perform the plugin adding method provided in any embodiment of the present disclosure, and has corresponding functional modules and beneficial effects for performing the plugin adding method.

It should be noted that the units and modules included in the preceding apparatus are only divided according to functional logic, but are not limited to the preceding division, as long as the corresponding functions can be implemented. In addition, the specific names of the functional units are only for distinguishing each other, and are not used to limit the protection scope of the embodiments of the present disclosure.

FIG. 7 is a structural diagram of an electronic device according to an embodiment of the present disclosure. Reference is made to FIG. 7 below, which illustrates a structural diagram of an electronic device 700 (such as a terminal device or a server in FIG. 7) suitable for implementing the embodiments of the present disclosure. The terminal device in the embodiment of the present disclosure may include, but is not limited to, mobile terminals such as a mobile phone, a laptop, a digital broadcast receiver, a personal digital assistant (PDA), a tablet computer (Pad), a portable multimedia player (PMP), and a vehicle-mounted terminal (such as a vehicle-mounted navigation terminal), and fixed terminals such as a digital TV and a desktop computer. The electronic device shown in FIG. 7 is only an example, and should not impose any limitation to the function and scope of use of the embodiments of the present disclosure.

As shown in FIG. 7, the electronic device 700 may include a processing apparatus (such as a central processing unit, a graphics processor, etc.) 701, which may perform various appropriate actions and processing according to a program stored in a read-only memory (ROM) 702 or a program loaded from a storage apparatus 708 into a random access memory (RAM) 703. The RAM 703 also stores various programs and data required for the operation of the electronic device 700. The processing apparatus 701, the ROM 702, and the RAM 703 are connected to each other through a bus 704. An input/output (I/O) interface 705 is also connected to the bus 704.

Generally, the following apparatus may be connected to the I/O interface 705: an input apparatus 706 including, for example, a touchscreen, a touchpad, a keyboard, a mouse, a camera, a microphone, an accelerometer, a gyroscope, or the like; an output apparatus 707 including, for example, a liquid crystal display (LCD), a speaker, a vibrator, or the like; a storage apparatus 708 including, for example, a magnetic tape, a hard disk, or the like; and a communication apparatus 709. The communication apparatus 709 may allow the electronic device 700 to perform wireless or wired communication with other devices to exchange data. Although FIG. 7 shows the electronic device 700 having various apparatus, it should be understood that not all of the illustrated apparatus are necessarily implemented or available. Alternatively, more or fewer apparatus may be implemented or available.

In particular, according to the embodiments of the present disclosure, the process described above with reference to the flowcharts may be implemented as a computer software program. For example, an embodiment of the present disclosure includes a computer program product, which includes a computer program carried on a non-transitory computer-readable medium, and the computer program includes program codes for executing the method shown in the flowcharts. In such an embodiment, the computer program may be downloaded and installed from the network through the communication apparatus 709, or installed from the storage apparatus 708, or installed from the ROM 702. When the computer program is executed by the processing apparatus 701, the preceding functions defined in the methods of the embodiments of the present disclosure are performed.

The names of messages or information exchanged between multiple apparatuses in implementations of the present disclosure are only used for illustrative purposes, and are not intended to limit the scope of such messages or information.

The electronic device provided in the embodiment of the present disclosure belongs to the same inventive concept as the plugin adding method provided in the preceding embodiment, and for the technical details not described in detail in this embodiment, reference may be made to the preceding embodiment, and this embodiment has the same beneficial effects as the preceding embodiment.

An embodiment of the present disclosure provides a computer storage medium having a computer program stored thereon, where the program, when executed by a processor, implements the plugin adding method provided in the preceding embodiments.

It should be noted that the preceding computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program, and the program may be used by or in conjunction with an instruction execution system, apparatus, or device. In the present disclosure, the computer-readable signal medium may include a data signal propagated in a baseband or as part of a carrier wave, and computer-readable program codes are carried in the data signal. The data signal propagated in this manner may be in multiple forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in conjunction with an instruction execution system, apparatus, or device. The program codes contained in the computer-readable medium may be transmitted by any suitable medium, including but not limited to an electrical wire, an optical cable, a radio frequency (RF), etc., or any suitable combination thereof.

In some implementations, clients and servers may communicate using any currently known or future developed network protocol, such as the HyperText Transfer Protocol (HTTP), and may be interconnected with any form or medium of digital data communication (for example, a communication network). Examples of the communication network include a local area network (LAN), a wide area network (WAN), an inter-network (for example, the Internet), a peer-to-peer network (for example, an ad hoc peer-to-peer network), and any currently known or future developed network.

The preceding computer-readable medium may be included in the preceding electronic device, or may exist alone without being assembled into the electronic device.

The preceding computer-readable medium carries one or more programs, and when the one or more programs are executed by the electronic device, the electronic device is caused to: present a target page, wherein at least one plugin adding area is provided in the target page; receive a plugin adding operation acting on the plugin adding area, and present a plugin editing area corresponding to the plugin adding operation; and receive a plugin editing operation acting on the plugin editing area, generate a target plugin based on edited plugin information, and add the target plugin to the plugin adding area.

The computer program codes for performing the operations of the present disclosure may be written in one or more programming languages or a combination thereof. The preceding programming languages include but are not limited to object-oriented programming languages such as Java, Smalltalk and C++, and conventional procedural programming languages such as C programming language or similar programming languages. The program codes may be executed entirely on a user computer, partly on a user computer, as a stand-alone software package, partly on a user computer and partly on a remote computer, or entirely on a remote computer or a server. In the scenario involving the remote computer, the remote computer may be connected to the user computer through any kind of network, including a local area network (LAN) or a wide area network (WAN), or the connection may be made to an external computer (for example, through the Internet using an Internet service provider).

The flowcharts and block diagrams in the drawings illustrate the architecture, functionality, and operation of possible implementations of the systems, methods, and computer program products according to various embodiments of the present disclosure. In this regard, each block in the flowcharts or block diagrams may represent a module, a program segment, or a portion of codes, and the module, the program segment, or the portion of codes contains one or more executable instructions for implementing specified logical functions. It should also be noted that, in some alternative implementations, the functions noted in the blocks may also occur out of the order noted in the drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a special-purpose hardware-based system that performs the specified functions or operations, or may also be implemented by a combination of special-purpose hardware and computer instructions.

The units involved in the embodiments of the present disclosure may be implemented in hardware or software. The name of a unit does not constitute a limitation of the unit itself under certain circumstances. For example, a first acquisition unit may also be described as “a unit for acquiring at least two Internet Protocol addresses”.

The functions described herein above may be performed, at least partially, by one or more hardware logic components. For example, without limitations, available exemplary types of hardware logic components include: a field-programmable gate array (FPGA), an application-specific integrated circuit (ASIC), an application-specific standard product (ASSP), a system on a chip (SOC), a complex programmable logic device (CPLD), etc.

In the context of the present disclosure, the machine-readable medium may be a tangible medium that may contain or store a program for use by or in conjunction with the instruction execution system, apparatus, or device. The machine-readable medium may be a machine-readable signal medium or a machine-readable storage medium. The machine-readable medium may include, but is not limited to, an electrical, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

According to one or more embodiments of the present disclosure, [Example 1] provides a plugin adding method, including:
presenting a target page, wherein at least one plugin adding area is provided in the target page;
receiving a plugin adding operation acting on the plugin adding area, and presenting a plugin editing area corresponding to the plugin adding operation; and
receiving a plugin editing operation acting on the plugin editing area, generating a target plugin based on edited plugin information, and adding the target plugin to the plugin adding area.

According to one or more embodiments of the present disclosure, [Example 2] provides the method of Example 1, further including:
optionally, the plugin editing area includes an operation permission editing area, and the plugin information includes an operation permission judgment condition; and
the receiving the plugin editing operation acting on the plugin editing area, and generating the target plugin to be added based on the edited plugin information includes:
receiving a condition editing operation acting on the operation permission editing area, and generating the target plugin to be added based on an operation permission judgment condition edited in the operation permission editing area.

According to one or more embodiments of the present disclosure, [Example 3] provides the method of Example 2, further including:
optionally, determining a response state of a page operation control based on an operation permission judgment condition corresponding to an operation permission detection plugin in response to a plugin trigger operation for the target plugin.

According to one or more embodiments of the present disclosure, [Example 4] provides the method of Example 1, further including:
optionally, the plugin editing area includes a data integration editing area, and the plugin information includes a data integration rule; and
receiving the plugin editing operation acting on the plugin editing area, and generating the target plugin to be added based on the edited plugin information includes:
receiving a rule editing operation acting on the data integration editing area, and generating the target plugin to be added based on a data integration rule edited in the data integration editing area.

According to one or more embodiments of the present disclosure, [Example 5] provides the method of Example 4, further including:
acquiring data to be processed corresponding to a plugin trigger operation in response to the plugin trigger operation for the target plugin; and
converting the data to be processed into target data based on a data integration rule corresponding to the target plugin.

According to one or more embodiments of the present disclosure, [Example 6] provides the method of Example 1, further including:
optionally, receiving the plugin adding operation acting on the plugin adding area includes:
receiving a plugin adding operation for a blank display area in the plugin adding area.

According to one or more embodiments of the present disclosure, [Example 7] provides the method of Example 6, further including:
optionally, receiving the target plugin based on the edited plugin information, and adding the target plugin to the plugin adding area includes:
generating a plugin identification and plugin detailed information of the target plugin based on the edited plugin information; and
configuring a response logic between the plugin detailed information and the plugin identification, and presenting the plugin identification or both the plugin identification and the plugin detailed information in the blank display area.

According to one or more embodiments of the present disclosure, [Example 8] provides the method of Example 1, further including:
optionally, receiving the plugin adding operation acting on the plugin adding area includes:
receiving a plugin adding operation acting on a page operation control in the plugin adding area.

According to one or more embodiments of the present disclosure, [Example 9] provides the method of Example 1, further including:
optionally, generating the target plugin based on the edited plugin information, and adding the target plugin to the plugin adding area includes:
generating the plugin detailed information of the target plugin based on the edited plugin information, and configuring the response logic between the plugin detailed information and the page operation control to add the target plugin to the plugin adding area; or
generating the plugin identification and the plugin detailed information of the target plugin based on the edited plugin information, and configuring the response logic between the plugin detailed information and the plugin identification and the response logic between the plugin identification and the page operation control to add the target plugin to the plugin adding area.

According to one or more embodiments of the present disclosure, [Example 10] provides the method of Example 1, further including:
optionally, the target plugin includes at least one of a navigation-type plugin, a view-type plugin, a work item tab-type plugin, a form item association plugin, a button-type plugin, a data integration-type plugin, and an event-type plugin. The form item association plugin includes at least one of a control-type plugin, a field-type plugin, and a form item container plugin.

According to one or more embodiments of the present disclosure, [Example 11] provides a plugin adding apparatus, including:
a page presenting module, which is configured to present a target page, wherein at least one plugin adding area is provided in the target page;
an editing area presenting module, which is configured to receive a plugin adding operation acting on the plugin adding area, and present a plugin editing area corresponding to the plugin adding operation; and
a plugin adding module, which is configured to receive a plugin editing operation acting on the plugin editing area, generate a target plugin based on edited plugin information, and add the target plugin to the plugin adding area.

The preceding description is only preferred embodiments of the present disclosure and an illustration of the applied technical principles. Those skilled in the art should understand that, the scope of disclosure involved in the present disclosure is not limited to the technical solutions formed by the specific combination of the preceding technical features, and should also cover, without departing from the preceding disclosed concept, other technical solutions formed by any combination of the preceding technical features or their equivalent features. For example, a technical solution formed by replacing the preceding features with technical features with similar functions disclosed in the present disclosure (but not limited to).

In addition, although operations are depicted in a particular order, this should not be understood as requiring that such operations are performed in the particular order shown or in a sequential order. Under certain circumstances, multitasking and parallel processing may be advantageous. Likewise, although the preceding discussion contains several specific implementation details, these should not be construed as limitations on the scope of the present disclosure. Certain features that are described in the context of separate embodiments may also be implemented in combination in a single embodiment. On the contrary, various features described in the context of a single embodiment may also be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. On the contrary, the specific features and actions described above are only example forms for implementing the claims.

1. A plugin adding method, comprising:
presenting a target page, wherein at least one plugin adding area is provided in the target page;
receiving a plugin adding operation acting on the plugin adding area, and presenting a plugin editing area corresponding to the plugin adding operation;
receiving a plugin editing operation acting on the plugin editing area, generating a target plugin based on edited plugin information, and adding the target plugin to the plugin adding area.

2. The plugin adding method according to claim 1, wherein the plugin editing area comprises an operation permission editing area, and the plugin information comprises an operation permission judgment condition;
the receiving the plugin editing operation acting on the plugin editing area, and generating the target plugin to be added based on the edited plugin information comprises:
receiving a condition editing operation acting on the operation permission editing area, and
generating the target plugin to be added based on an operation permission judgment condition edited in the operation permission editing area.

3. The plugin adding method according to claim 2, wherein the plugin adding method further comprises:
determining a response state of a page operation control based on an operation permission judgment condition corresponding to an operation permission detection plugin in response to a plugin trigger operation for the target plugin.

4. The plugin adding method according to claim 1, wherein the plugin editing area comprises a data integration editing area, and the plugin information comprises a data integration rule;
the receiving the plugin editing operation acting on the plugin editing area, and generating the target plugin to be added based on the edited plugin information comprises:
receiving a rule editing operation acting on the data integration editing area, and generating the target plugin to be added based on a data integration rule edited in the data integration editing area.

5. The plugin adding method according to claim 4, wherein the plugin adding method further comprises:
acquiring data to be processed corresponding to a plugin trigger operation in response to the plugin trigger operation for the target plugin;
converting the data to be processed into target data based on a data integration rule corresponding to the target plugin.

6. The plugin adding method according to claim 1, wherein the receiving the plugin adding operation acting on the plugin adding area comprises:
receiving a plugin adding operation acting on a blank display area in the plugin adding area.

7. The plugin adding method according to claim 6, wherein the generating the target plugin based on the edited plugin information, and adding the target plugin to the plugin adding area comprises:
generating a plugin identification and plugin detailed information of the target plugin based on the edited plugin information;
configuring a response logic between the plugin detailed information and the plugin identification, and presenting the plugin identification or both the plugin identification and the plugin detailed information in the blank display area.

8. The plugin adding method according to claim 1, wherein the receiving the plugin adding operation acting on the plugin adding area comprises:
receiving a plugin adding operation acting on a page operation control in the plugin adding area.

9. The plugin adding method according to claim 1, wherein the generating the target plugin based on the edited plugin information, and adding the target plugin to the plugin adding area comprises:
generating the plugin detailed information of the target plugin based on the edited plugin information, and configuring the response logic between the plugin detailed information and the page operation control to add the target plugin to the plugin adding area; or
generating the plugin identification and the plugin detailed information of the target plugin based on the edited plugin information, and configuring the response logic between the plugin detailed information and the plugin identification and the response logic between the plugin identification and the page operation control to add the target plugin to the plugin adding area.

10. The plugin adding method according to claim 1, wherein the target plugin comprises at least one of a navigation-type plugin, a view-type plugin, a work item tab-type plugin, a form item association plugin, a button-type plugin, a data integration-type plugin, and an event-type plugin, wherein the form item association plugin comprises at least one of a control-type plugin, a field-type plugin, and a form item container plugin.

11. (canceled)

12. An electronic device, comprising:
one or more processors; and
a memory, which is configured to store one or more programs,
wherein the one or more programs, when executed by the one or more processors, cause the one or more processors to implement a plugin adding method, comprising:
presenting a target page, wherein at least one plugin adding area is provided in the target page;
receiving a plugin adding operation acting on the plugin adding area, and presenting a plugin editing area corresponding to the plugin adding operation;
receiving a plugin editing operation acting on the plugin editing area, generating a target plugin based on edited plugin information, and adding the target plugin to the plugin adding area.

13. A non-transitory computer-readable storage medium containing computer-executable instructions, wherein the computer-executable instructions, when executed by a computer processor, are configured to perform a plugin adding method, comprising:
presenting a target page, wherein at least one plugin adding area is provided in the target page;
receiving a plugin adding operation acting on the plugin adding area, and presenting a plugin editing area corresponding to the plugin adding operation;
receiving a plugin editing operation acting on the plugin editing area, generating a target plugin based on edited plugin information, and adding the target plugin to the plugin adding area.

14. The electronic device according to claim 12, wherein the plugin editing area comprises an operation permission editing area, and the plugin information comprises an operation permission judgment condition;
the receiving the plugin editing operation acting on the plugin editing area, and generating the target plugin to be added based on the edited plugin information comprises:
receiving a condition editing operation acting on the operation permission editing area, and generating the target plugin to be added based on an operation permission judgment condition edited in the operation permission editing area.

15. The electronic device according to claim 14, wherein the plugin adding method further comprises:
determining a response state of a page operation control based on an operation permission judgment condition corresponding to an operation permission detection plugin in response to a plugin trigger operation for the target plugin.

16. The electronic device according to claim 12, wherein the plugin editing area comprises a data integration editing area, and the plugin information comprises a data integration rule;
the receiving the plugin editing operation acting on the plugin editing area, and generating the target plugin to be added based on the edited plugin information comprises:
receiving a rule editing operation acting on the data integration editing area, and generating the target plugin to be added based on a data integration rule edited in the data integration editing area.

17. The electronic device according to claim 16, wherein the plugin adding method further comprises:
acquiring data to be processed corresponding to a plugin trigger operation in response to the plugin trigger operation for the target plugin;
converting the data to be processed into target data based on a data integration rule corresponding to the target plugin.

18. The non-transitory computer-readable storage medium according to claim 13, wherein the plugin editing area comprises an operation permission editing area, and the plugin information comprises an operation permission judgment condition;
the receiving the plugin editing operation acting on the plugin editing area, and generating the target plugin to be added based on the edited plugin information comprises:
receiving a condition editing operation acting on the operation permission editing area, and generating the target plugin to be added based on an operation permission judgment condition edited in the operation permission editing area.

19. The non-transitory computer-readable storage medium according to claim 18, wherein the plugin adding method further comprises:
determining a response state of a page operation control based on an operation permission judgment condition corresponding to an operation permission detection plugin in response to a plugin trigger operation for the target plugin.

20. The non-transitory computer-readable storage medium according to claim 13, wherein the plugin editing area comprises a data integration editing area, and the plugin information comprises a data integration rule;
the receiving the plugin editing operation acting on the plugin editing area, and generating the target plugin to be added based on the edited plugin information comprises:
receiving a rule editing operation acting on the data integration editing area, and generating the target plugin to be added based on a data integration rule edited in the data integration editing area.

21. The non-transitory computer-readable storage medium according to claim 20, wherein the plugin adding method further comprises:
acquiring data to be processed corresponding to a plugin trigger operation in response to the plugin trigger operation for the target plugin;
converting the data to be processed into target data based on a data integration rule corresponding to the target plugin.
